(19) United States
(12) Patent Application Publication
(10) Pub. No.: US 2007/0015659 A1
(43) Pub. Date: Jan. 18, 2007

(54) Receiver medium for inkjet or thermal dye transfer printing

(76) Inventors: Sean O'Kell, Manningtree, Essex (GB); Ian Stephen, Felsted, Essex (GB)

Correspondence Address: MORGAN LEWIS & BOCKIUS LLP, 1111 PENNSYLVANIA AVENUE NW, WASHINGTON, DC, 20004, US

(21) Appl. No.: 10/557,051

(22) PCT Filed: May 12, 2004
(86) PCT No.: PCT/GB04/02034

§ 371 Date: Nov. 16, 2005

(30) Foreign Application Priority Data
May 22, 2003 (GB) 0311791.8

(51) Int. Cl. B41M 5/24

(52) U.S. Cl. 503/201

(57) ABSTRACT

Receiver medium for electronic printing comprises an elongate sheet of material (12) at least one surface of which is capable of receiving an image by electronic printing, at least one longitudinal line of weakness (14, 16, 18) running along the length of the sheet, the sheet being in the form of a roll and the or each line of weakness being rupturable to part the sheet through the complete thickness thereof. The longitudinal line or lines of weakness divide the sheet into two or more regions (20, 22, 24, 26), each in the form of an elongate strip. In use, the receiver medium is fed to a printer in conventional manner, and typically two or more images (24, 26) printed electronically, side-by-side across the width of the sheet, one in each region. The sheet is then cut transversely (A-A, B-B), e.g. by a guillotine forming part of a printer, to sever the printed part from the remainder of the roll of medium. The side-by-side images can then be separated by rupturing the sheet along the line or lines of weakness, producing individual images.

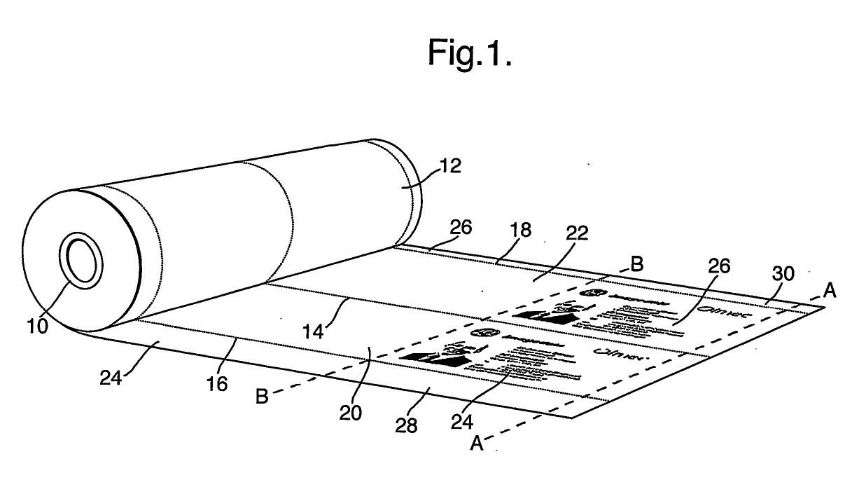

### FIELD OF THE INVENTION

This invention relates to receiver medium for electronic printing.

### BACKGROUND TO THE INVENTION

Several forms of electronic printing are currently in common use that can be used for the generation of images that are of near photographic quality. The best known of these are inkjet and thermal dye transfer printing.

An inkjet printing process uses an array of nozzles to deposit droplets of ink at precisely controlled positions on a receiver medium. The quality of the print obtained depends in part on the interaction between the ink droplets and the receiver medium and the way in which the latter controls their movement. The inks used are typically an aqueous solution of dyes, with additional components to control evaporation, viscosity and other physical properties. The inks can also be based on pigments rather than dyes and can optionally be carried in an oil-based rather than a water-based vehicle. Typically, the ink colours used are cyan, magenta, yellow and black. For the highest quality printing of images, additional inks are often used:. These are typically pale cyan and pale magenta, thus allowing a greater degree of control over the colour while increasing the volume of ink that must be deposited

Thermal dye transfer printing is a well known process in which one or more thermally transferable dyes are transferred from selected areas of a ribbon to a receiver material by localised application of heat, thereby to form an image. The colours on the ribbon are typically applied as a solid solution of dye in polymer to one surface of the ribbon. Full colour images can be produced in this way using dyes of the three primary colours, yellow, magenta and cyan. The resulting images are of near photographic quality and may be printed onto paper-like media so that they can be used as photographs. Mass transfer printing is another well known technique in which colorant material (commonly carbon black) is transferred from a mass transfer medium to a receiver material by localised application of heat. Mass transfer printing is generally used to print monochrome images, commonly text, bar codes etc. Thermal dye transfer printing and mass transfer printing are often used in conjunction with one another, with a common application being the printing of personalised cards such as identification cards, credit cards, driving licences etc, bearing a lull colour image of the head of a person and text and/or a bar code in monochrome (usually black). Such printing is conveniently carried out using a ribbon of a heat-resistant substrate, typically polyethylene terephthalate film, carrying a plurality of similar sets of different coloured dye coats and colorant, each set comprising a panel of each dye colour (yellow, magenta and cyan) and a panel of colorant, with the panels being in the form of discrete stripes extending transverse to the length of the ribbon, and arranged in a repeated sequence along the length of the ribbon.

Heat is commonly applied by use of a thermal head, which consists of a line of closely packed heated elements which are in contact with the surface of the ribbon opposite to that bearing the dye panels. The elements of the head are heated electrically for periods of typically a few ms in order to transfer the desired amount of dye in the appropriate part of the image.

Typically, both inkjet and thermal dye printers have in the past been unable to print right up to the edge of the image receiving media, thus leaving a white border around the print. For aesthetic reasons it is often desirable to be able to provide a print with no white borders, otherwise known as a full-bleed print.

Typically, also, both inkjet and thermal dye printers have in the past been fed with individual sheets of paper from a stack. One method that has been used to print full-bleed images from such sheet-fed printers uses receiving media with perforated borders as in U.S. Pat. No. 5,825,996. The image printed is larger than the central area bounded by the perforations, and after printing the perforations are broken and the trims discarded to yield a fill-bleed image of the desired size. Perforated inkjet media have been proposed in U.S. Pat. No. 5,853,837 in which a number of business card sized areas are laid out in a grid on an A4 sheet of paper. Also, U.S. Pat. No. 6,040,918 discloses a multi-layer tape having an image-receiving layer and a backing layer. The image-receiving layer is perforated to enable image-bearing regions to be peeled away from the backing layer to form labels.

Papers for thermal dye transfer printing have been proposed in which a grid of perforations has been applied to a sheet in order to provide, for example, business cards after printing of the sheet and separation of the perforations, as in Japanese Patent Application publication number 10-230686 (Sony).

More recent designs of ink jet printer are capable of printing right up to the edge of a sheet of paper. They can also accept rolls of paper that are then guillotined to the length of the image by a cutter built into the printer.

Similarly, within the dye sublimation printer field, several machine designs use roll fed paper coupled with a guillotine to produce full bleed prints. In these machines, the length of a print is governed by the panels on the ribbon, and the width of the print is determined by the width of the paper roll. The final prints are guillotined in the printer with the cut area encroaching into the print to ensure a full bleed image is produced.

An inkjet printer works most efficiently when printing the full width of which it is capable. This is because the head carrying the jets scans across the width of the paper to be printed and then reverses. If this paper width is less than the full width, then a greater proportion of the total time is taken up with the process of reversing the direction of travel at either end of each printing traverse.

In thermal dye transfer printing, the efficiency is even more dependent on using as much of the width of the thermal head as possible. This is because a fixed time is required to transfer the dye for each line printed, so that the linear speed of the media under the head is independent of the width being printed. The full capabilities of the printer are therefore not being used if only a narrow roll of paper is printed in the machine. It is also wasteful of ribbon if only part of the ribbon is used for printing, so in practice it is necessary to use a ribbon manufactured specifically for the width of paper to be printed. This need for many sizes of ribbon increases the cost, and it is inconvenient to have to change the ribbon as well as the paper when the format is changed. There is thus a need to provide a choice of print sizes even in printers capable of full-bleed printing.

In a sheet-fed printer, perforated sheets can be used in the manner commonly seen with label stock, so that a whole page is printed and then separated along the perforations. This is not practicable for a roll-fed printer, as it is difficult to print the images in proper registration with the transverse perforations. The perforations themselves, especially if they are micro-perforations designed to give a smooth edge after separation, are very difficult to detect optically. It is therefore necessary to have some kind of registration mark, e.g. on the back of the paper to be printed. This is often unacceptable in the final printed image.

It is therefore desirable to have a means of printing a number of images side by side on a roll of paper and then separating them into smaller images for their final purpose.

### SUMMARY OF THE INVENTION

In a first aspect the present invention provides receiver medium for electronic printing, comprising an elongate sheet of material at least one surface of which is capable of receiving an image by electronic printing, at least one longitudinal line of weakness running along the length of the sheet, the sheet being in the form of a roll and the or each line of weakness being rupturable to part the sheet through the complete thickness thereof.

The longitudinal line or lines of weakness divide the sheet into two or more regions, each in the form of an elongate strip and the regions are preferably interconnected solely through the lines of weakness. Separate images can be electronically printed side-by-side, one on each region, for subsequent separation. Additionally or alternatively, lines of weakness may define edge strips intended to be removed and discarded. Such removable edge strips may be used, e.g., to permit production of a single full-bleed image, with the image encroaching slightly into the edge regions, or to match the useful width of a receiver medium to that of a particular thermal dye transfer ribbon.

In use, the receiver medium is fed to a printer in conventional manner, and typically two or more images printed electronically, side-by-side across the width of the sheet, one in each region. The sheet is then cut transversely, to sever the printed part from the remainder of the roll of medium. The side-by-side images can then be separated by rupturing the sheet along the line or lines of weakness, producing individual images.

In a further aspect, the present invention provides a method of electronic printing of images, comprising supplying to an electronic printer receiver medium comprising an elongate sheet of material at least one surface of which is capable of receiving an image by electronic printing, at least one longitudinal line of weakness running along the length of the sheet; printing one or more side-by-side images across the width of the sheet, the or each image being bounded on one or both sides by a line of weakness of the medium; cutting the medium transversely to separate the printed region from the remainder of the medium; and rupturing the line or lines of weakness to part the sheet through the complete thickness thereof and thereby separate the image or images.

The receiver medium is preferably in accordance with the first aspect of the invention.

Where the invention is used to produce a single full-bleed image, usually across most of the width of the medium, with the image encroaching slightly into removable edge strips of the medium, the edges of the printed image extend slightly over longitudinal lines of weakness defining the removable edge strips. In this case, while the edges of the image do not coincide exactly with the longitudinal lines of weakness, it is nevertheless to be considered that the image is bounded on both sides by a line of weakness.

More usually, the invention is used to produce two or more side-by-side images across the width of the sheet, adjacent images being separated by a line of weakness.

Thus, in a preferred aspect, the present invention provides a method of electronic printing of multiple images, comprising supplying to an electronic printer receiver medium in accordance with the invention; printing two or more side-by-side images across the width of the medium and separated by a longitudinal line of weakness of the medium; cutting the medium transversely to separate the printed region from the remainder of the medium; and rupturing the line or lines of weakness to separate the images.

The transverse cutting is preferably performed by a guillotine, that preferably forms part of the printer, and that may be controlled by software in known manner.

The receiver medium thus includes only longitudinal line or lines of weakness, and no transverse lines of weakness, as transverse separation is achieved by cutting.

The longitudinal line or lines of weakness are usually arranged symmetrically. In the simplest case, a single line of weakness runs along the length of the sheet, along the centre line thereof, for producing two similarly sized side-by-side images. Where three side-by-side images are required, two lines of weakness run along the length of the sheet. In some cases it may be desired to remove outer edge strips from the sheet, to be discarded. In this case additional lines of weakness run along the length of the sheet, suitably spaced from the edges. Asymmetrical lines of weakness may also be employed, e.g. with a single line of weakness displaced to one side of the centre line to permit side-by-side printing of a larger print in landscape format and a smaller print in portrait format.

The or each line of weakness is conveniently in the form of a line of perforations, e.g. microperforations, which may be formed in known manner. Alternatively, the or each line of weakness may be in the form of a partial cut line, extending part way through the thickness of the material, e.g. forming a so-called substantial-cut line as described in U.S. Pat. No. 5,853,837.

The line or lines of weakness may be ruptured manually to separate images. Alternatively mechanical separation means may be used for this purpose, in known manner.

The medium may otherwise be of conventional construction and materials, suited to the particular form of printing to be employed, and many suitable media are well known to those skilled in the art.

The medium is in the form of a roll, generally being wound on a core to provide support and structural stability. The core is usually tubular and is typically of rigid materials such as cardboard, ABS, acetal, polystyrene, acrylic, PVC, polycarbonate, metal etc. The roll may also be formed without the use of a core by means common in the art, such as the use of a hydraulic mandrel. The perforations may extend the full length of the roll, or optionally may be omitted at either or both ends in order to simplify handling in manufacture or when loading the printer.

The invention may be applied generally to electronic printing, especially inkjet printing and thermal dye transfer printing, with the medium having a suitable surface for printing by the technique in question.

In a first embodiment of the invention as applied to thermal dye transfer printing, the lengths of each dye panel along the printing ribbon correspond to one dimension of the final printed images. Thus, a number of images are printed side by side, then cut, e.g. guillotined by the printer, and then separated along the line or lines of weakness by an end-user. These images are typically full-bleed images. In this way, two or more images emerge simultaneously from the printer and are then separated manually. The printer may be arranged to give full-bleed images with no edge trim, or arranged so that printing continues across the line of weakness of an edge trim, which is separated after printing.

In a second embodiment, several images are printed side by side, but also successively along the roll, so that a longer dye panel can be accommodated. Thus, the length of each dye panel corresponds to an integer multiple of one dimension of the final printed images. As these images emerge from the printer, they are transversely cut, e.g. guillotined, at suitable points to separate them from the roll before being separated manually at the lines of weaknesses. The images are presented in a similar fashion to the first embodiment, except that several sets emerge together from the printer on each cycle.

In a third embodiment of the invention, a multi-head dye thermal transfer printer is used with a separate head and ribbon for each colour and overlay panel to be printed. The images are cut, e.g. guillotined, after printing and separated by hand. Very rapid printing is obtainable in this way, together with great flexibility of the format.

It will be further recognised that where a specific size of print is desired, it may be preferable, even with a printer capable of providing full-bleed, to provide the paper roll with lines of weakness defining edge portions that are to be removed or discarded, if that allows the use of a ribbon format that is already available.

The images produced by printing in this way may be identical on each sheet, or may be all different. It is particularly desirable to produce identical prints for applications such as business cards, passport photographs, etc. Production of sample prints, for example from a digital camera memory card, may require all the images to be different.

The invention finds particular application in the production of business cards and/or photographic images. The invention includes within its scope printed material produced by use of the medium or method of the invention, especially business cards.

### DETAILED DESCRIPTION OF THE INVENTION

Embodiments of the invention will now be described, by way of illustration, and with reference to the accompanying drawing, the single FIGURE of which is a schematic illustration of one embodiment of receiver medium in accordance with the invention.

The FIGURE shows a roll of Olmec OP500 thermal dye transfer receiver sheet (Olmec and OP500 are Trade Marks of ICI Imagedata), comprising a tabular core 10 carrying an elongate sheet 12 of receiver material 127 mm wide. The sheet is perforated along three parallel lines, extending along the full length of the sheet, forming three longitudinal lines of weakness, with a central line of perforations 14 and two edge lines of perforations 16 and 18 each 8.5 mm from the adjacent edge. The lines of perforations thus divide the sheet into four elongate strips: two centre portions 20 and 22, each 55 mm wide, and two edge strips 24 and 26, each 8.5 mm wide.

In use, the receiver sheet is loaded into a suitable thermal dye transfer printer (not shown), e.g. an Olmec OP500 printer, in conventional manner. The printer includes a 5″×3.5″ (127 mm×89 mm) format thermal dye transfer ribbon, comprising sets of panels of different colour dye coats and colourant, as described above, a printing head and a guillotine.

The printer was used in conventional manner, under control of suitable software, to print two side-by-side identical images 24 and 26 (i.e. in a 2 up format) each comprising a photo ID image and personal information. Image 24 was formed on portion 20 of the receiver sheet and image 26 was formed on portion 22 of the receiver sheet. After printing, the sheet was transversely guillotined by the printer along line A-A and line B-B. The operation of the printer requires the presence of an 8 mm long leader, which is printed only sufficiently to overlap the guillotine line. The printer trims this along line A-A after printing, and the waste (8 mm×the paper width) drops into a waste tray inside the printer. The trailing edge of the print also slightly overlaps the line B-B. The 8 mm wide trimmings, thus have a line of colour along either edge, one corresponding to the trailing edge of the previous print, and the other to the leading edge of the current print. Guillotining was performed automatically by the printer, under suitable software control, on ejection of the print from the printer. The process thus resulted in ejection from the printer of a single unit in the form of a strip of medium, transversely cut from the sheet, and comprising two side-by-side printed portions 24 and 26 and two edge strip portions 28 and 30, the portions being separated by lines of perforations. The perforations can be readily ruptured manually (or by use of a mechanical separator), to give two waste edge strips 28 and 30 and two identical photo quality business cards 24 and 26 of 55 mm×89 mm.

In the above embodiment, the edge lines of perforations 16 and 18 are simply employed to make the receiver medium compatible with the width of the ribbon used. If the receiver medium and ribbon were of the same width, the edge perforations would not be required. However, the margins may be used for converting the printed cards into a tear-off pad for easy dispensing. The cards are separated along the central line of perforations 14 and are then collected into two piles. The cards in each pile are then grouped into a block using for example staples through the margins or a hot melt adhesive applied along the edge.

In a modification of the above, a similar but slightly wider sheet 12 was provided with two equidistant longitudinal lines of perforations. Three side-by-side images were printed on this, to give three prints each 45 mm×89 mm.

In a further embodiment, a roll of Olmec OP500 receiver sheet of width 152 mm was provided with a central line of perforations and was loaded into an Olmec OP500 printer with a 152 mm×230 mm format printing ribbon. Four images were printed in a 2×2 arrangement, and the printer caused to guillotine the images at positions corresponding the beginning, middle and end of the finished print. This produced two pairs of images, each of which was separated by hand-rupturing of the perforations to give four images each 76 mm×115 mm.

In a further embodiment, a roll of Olmec OP600 receiver sheet of width 152 mm was provided with a single line of perforations 50 mm from one edge and was loaded into an Olmec OP600 printer with a 152 mm×102 mm format printing ribbon. Three images were printed in a 3×1 arrangement, each image being 152 mm wide and 34 mm long. The printer was caused to guillotine the images at the beginning, twice within the print, and at the end of the finished print. This produced three images, each of which could then be further separated by hand-rupturing of the perforations into a portion of 102 mm×34 mm and one of 50 mm×34 mm. The smaller portion of the image is typically used as a detachable stub on a ticket, which may carry machine readable information such as a bar-code in addition to images and text.

In a further embodiment, a roll of Olmec OP600 receiver sheet of width 152 mm was provided with four equidistant lines of perforations and was loaded into an Olmec OP600 printer with a 152 mm×230 mm format printing ribbon. Twenty images were printed in a 4×5 arrangement, and the printer caused to guillotine the images at the beginning, four times within the print, and at the end of the finished print. This produced five strips of images, each of which was separated by hand-rupturing of the perforations to give four images each 38 mm×46 mm, thus producing standard photo ID size images without the need for further'trimming.

In each of the described embodiments, the receiver sheet emerges from the roll with exposed surfaces, one of which receives the image or images by electric printing, after which the transverse cuts are made automatically by the guillotine under the control of the printer. After this, the line or lines of weakness are ruptured to part the sheet through the complete thickness thereof. Prior to this rupturing, the regions of the sheet defined by the line or lines of weakness are interconnected solely through the line or lines of weakness.

1. A receiver medium for electronic printing, comprising an elongate sheet of material at least one surface of which is capable of receiving an image by electronic printing, at least one longitudinal line of weakness running along the length of the sheet, the sheet being in the form of a roll and the or each line of weakness being rupturable to part the sheet through the complete thickness thereof.

2. Receiver medium according to claim 1, wherein a line of weakness runs along the centre line of the sheet.

3. Receiver medium according to claim 1, wherein a line of weakness runs along the sheet, displaced to one side of the centre line thereof.

4. Receiver medium according to claim 1, wherein two lines of weakness run along the length of the sheet, for producing three side-by-side images.

5. Receiver medium according to claim 4, wherein the lines of weakness are symmetrically arranged.

6. Receiver medium according to claim 1, including lines of weakness defining edge strips intended to be removed and discarded.

7. Receiver medium according to claim 1, wherein the line or lines of weakness comprise perforations.

8. Receiver medium according to claim 7, wherein the perforations comprise microperforations.

9. Receiver medium according to claim 1, wherein the line or lines of weakness comprise a partial cut line.

10. Receiver medium according to claim 1, wherein the line or lines of weakness divide the sheet into two or more regions which are interconnected solely through the line or lines of weakness.

11. Receiver medium according to claim 1, for receiving an image by thermal dye transfer printing.

12. Receiver medium according to claim 1, for receiving an image by inkjet printing.

13. A method of electronic printing of images, comprising supplying to an electronic printer receiver medium comprising an elongate sheet of material at least one surface of which is capable of receiving an image by electronic printing, at least one longitudinal line of weakness running along the length of the sheet; printing one or more side-by-side images across the width of the sheet, the or each image being bounded on one or both sides by a line of weakness of the medium; cutting the medium transversely to separate the printed region from the remainder of the medium; and rupturing the line or lines of weakness to part the sheet through the complete thickness thereof and thereby separate the image or images.

14. A method according to claim 13, wherein the receiver medium comprises an elongate sheet of material at least one surface of which is capable of receiving an image by electronic printing, at least one longitudinal line of weakness running along the length of the sheet. the sheet being in the form of a roll and the or each line of weakness being rupturable to part the sheet through the complete thickness thereof.

15. A method according to claim 13, wherein transverse cutting is performed by a guillotine.

16. A method according to claim 13, wherein the line or lines of weakness are ruptured manually.

17. A method according to claim 13, wherein two or more side-by-side images are printed across the width of the sheet, adjacent images being separated by a line of weakness.

18. A method according to claim 13, wherein the printer is a thermal dye transfer printer using a printing ribbon comprising dye panels.

19. A method according to claim 18, wherein the length of each dye panel of the printing ribbon correspond to one dimension of the final printed images.

20. A method according to claim 18, wherein the length of each dye panel of the printing ribbon correspond to an integer multiple of one dimension of the final printed images.

21. A method according to claim 18, wherein the printer is a multi-head dye thermal transfer printer.

22. A method according to claim 13, wherein the printer is an inkjet printer.

23. A method in accordance with claim 13, to produce business cards.

24. A method in accordance with claim 13 to produce photographic images.

25. A business card or photographic image produced by the method according to claim 13.

26. A business card or photographic image comprising the medium of claim 1.

27. A method according to claim 15 wherein the guillotine forms part of the printer.
